(19) United States
(12) Patent Application Publication
(10) Pub. No.: US 2024/0104603 A1
(43) Pub. Date: Mar. 28, 2024

(54) MATCHING USER INFORMATION BETWEEN DATA SETS, WHILE PRESERVING DATA PRIVACY

(71) Applicant: Foursquare Labs, Inc., New York, NY (US)

(72) Inventors: Daniel Hebert, New York, NY (US); Aileen Li, New York, NY (US); James Kung, New York, NY (US)

(21) Appl. No.: 17/935,828

(22) Filed: Sep. 27, 2022

(51) Int. Cl. G06Q 30/02

(52) U.S. Cl. CPC G06Q 30/0261; G06Q 30/0205

(57) ABSTRACT

Methods and systems for matching user information between data sets, while preserving data privacy are provided. Some examples relate to matching subsets of users from a first device to subsets of users from a second device, based on a first set of indications and a second set of indications, respectively, to calculate how long it takes for a user to travel to a location of interest, after the user is provided with directed content. A conversion rate may be determined based on how many instances at which a user travels to the location of interest, within a conversion window, after the user is provided with the directed content. The conversion rate may be compared to a baseline conversion rate to determine a change in conversion rate. The change in conversion rate may correspond to an impact of the directed content in causing the user to travel to the location of interest. User data is not shared from the first device to the second device, and vice-versa.

### BACKGROUND

Services may store data corresponding to specific users and provide directed content to the specific users for a desired purpose (e.g., to influence the users to travel to a location of interest, such as a venue). Computing devices may track location data of specific users, which can be used to determine when the specific users travel to the location of interest (e.g., which corresponds to the content provided to the specific users, by the services). However, to protect privacy of the specific users, the services and computing devices may desire to keep user information inaccessible by each other. Accordingly, it can be difficult to match data from the services (e.g., content data) to data from the computing devices (e.g., location data), without allowing the services and computing devices to access each other's respective data sets.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to methods and systems for matching user information between data sets, while preserving data privacy. Some aspects relate to matching subsets of users from a first device to subsets of users from a second device, based on a first set of indications and a second set of indications, respectively, to calculate how long it takes for a user to travel to a location of interest, after the user is provided with directed content. A conversion rate may be determined based on how many instances at which a user travels to the location of interest, within a conversion window, after the user is provided with the directed content. The conversion rate may be compared to a baseline conversion rate to determine a change in conversion rate. The change in conversion rate may correspond to an impact of the directed content in causing the user to travel to the location of interest. User data is not shared from the first device to the second device, and vice-versa.

This summary is provided to introduce a selection of concepts in a simplified form that are further described below in the Detailed Description. This summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 illustrates an overview of an example system according to some aspects described herein.

FIG. 2 illustrate a detailed view of the computing device of FIG. 1, according to some aspects described herein.

FIG. 3 illustrates a detailed view of the service device of FIG. 1, according to some aspects described herein.

FIG. 4 illustrates a detailed view of the server of FIG. 1, according to some aspects described herein.

FIG. 5 illustrates an example use-case for matching user information between data sets, while preserving data privacy, according to some aspects described herein.

FIG. 6 illustrates an example method, according to some aspects described herein.

FIG. 7 illustrates an example method, according to some aspects described herein.

FIG. 8 illustrates a block diagram illustrating example physical components of a computing device with which aspects of the disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

As mentioned above, services may store data corresponding to specific users and provide content to the specific users for a desired purpose (e.g., to influence the users to travel to a location of interest, such as a venue). Computing devices may track location data of specific users, which can be used to determine when the specific users travel to the location of interest (e.g., which corresponds to the content provided to the specific users, by the services). However, to protect privacy of the specific users, the services and computing devices may desire to keep user information inaccessible by each other. Accordingly, it can be difficult to match data from the services (e.g., content data) to data from the computing devices (e.g., location data), without allowing the services and computing devices to access each other's respective data sets.

For example, a service (e.g., gaming service, medical service, commercial service, etc.) may provide directed content to a user that influences them to go to a location of interest (e.g., a park, a stadium, a clinic, a store, a website, etc.). The service may have a pre-determined conversion window that specifies a duration within which the service desires to measure if the user goes to the location of interest (e.g., five days, ten days, two weeks, etc.). The user's computing device may receive location data corresponding to when the user goes to the location of interest. However, the service may not want to share its information with applications on the computing device, while applications on the computing device may not want to share their information with the service. Therefore, calculations are unable to be performed based on information stored within a data set of the service and a data set of applications on the computing device.

Accordingly, some aspects of the present disclosure relate to methods, systems, and media for matching user information between data sets, while preserving data privacy. Generally, a first device may provide location data corresponding to a first set of users being at a location of interest, first timestamps corresponding to the location data, and a first set of indications (e.g., labels) that each correspond to a respective user from the first set of users. A second device may provide a second set of indications that correspond to a second set of users, and second timestamps that correspond to when each of the users from the second set of users were provided with directed content (e.g., content designed to influence a user to perform an action, such as going to a venue). A matched subset may be determined of users who are in both of the first set of users and the second set of users, based on the first indications and the second set of indications. The matched subset may be determined independent of the first device and the second device, such that information provided by the first device is inaccessible by the second device, and vice versa.

Additionally, or alternatively, some aspects of the present disclosure relate to methods, systems, and media for determining an impact of directed content on influencing users to perform a given action (e.g., go to a physical location, go to a virtual location, go to a specific website, purchase a product, etc.). After the matched subset is determined, based on mechanisms discussed above, and further herein, a real conversion rate may be determined based on the first timestamps (discussed above) and the second timestamps (discussed above). A change between the real conversion rate and a baseline conversion rate may be determined, thereby determining an impact of the directed content.

Advantages of mechanisms disclosed herein may include improved privacy for user data, where devices that provide independent, respective sets of data, may be unable to access each other's sets of data, while calculations can still be performed based on the sets of data. In this respect, mechanisms performed herein may be described as a “clean room” in which datasets are joined for calculations to be performed, in a privacy-centric setup, in which neither party that inputs data to the clean room has access to another party's data.

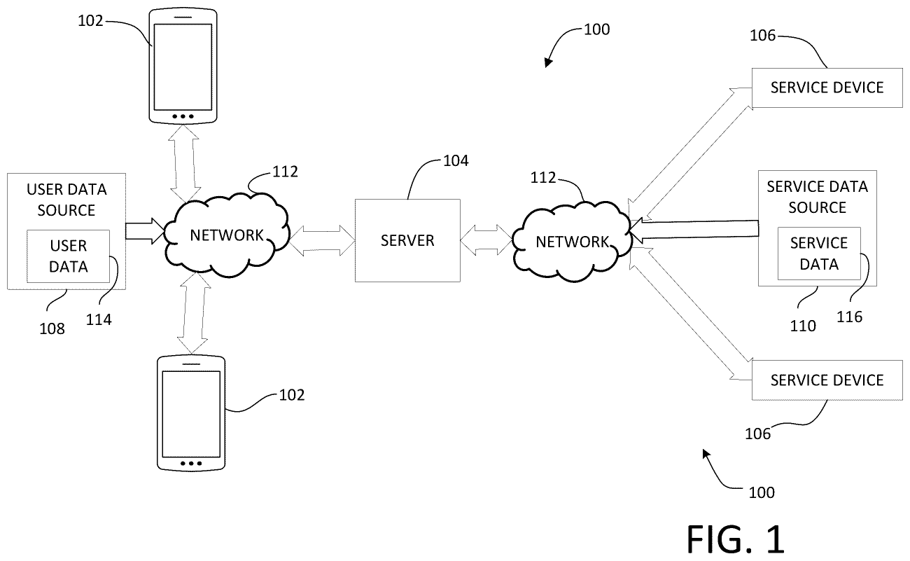

FIG. 1 shows an example of a system 100, in accordance with some aspects of the disclosed subject matter. The system 100 may be a system for matching user information between data sets, while preserving data privacy. Additionally, or alternatively, the system 100 may be a system for determining an impact of directed content on influencing users to perform a given action. The system 100 includes one or more computing devices 102, one or more servers 104, one or more service devices 106, one or more user data sources 108, one or more service data sources 110, and one or more communication networks or networks 112.

The computing device 102 can receive user data 114 from the user data source 108, which may include, for example a database, a microphone, a camera, a global positioning system (GPS), or some other sensor that transmits user data, a computer-executed program that generates user data, and/or memory with data stored therein corresponding to user data. The user data 114 may include personal identifying information of a user, demographic information of a user, information corresponding to an operating system of a user's device, location data, and/or other types of user data that may be recognized by those of ordinary skill in the art.

Additionally, or alternatively, the network 112 can receive user data 114 from the user data source 108, which may include, for example a database, a microphone, a camera, a global positioning system (GPS), or some other sensor that transmits user data, a computer-executed program that generates user data, and/or memory with data stored therein corresponding to user data. The user data 114 may include personal identifying information of a user, demographic information of a user, information corresponding to an operating system of a user's device, location data, and/or other types of user data that may be recognized by those of ordinary skill in the art.

The service device 106 can receive service data 116 from the service data source 110, which may include, for example a computer-executed program that generates service data, and/or memory with data stored therein corresponding to service data. The service data 116 may include personal identifying information of a user, directed content to be sent to one or more users, a pre-configured conversion window during which it is desired for a user to perform an action, after receiving directed content, and/or other types of service data that may be recognized by those of ordinary skill in the art. In some examples, the service data 116 may include information corresponding to a marketing campaign, a video game, or an education campaign.

Additionally, or alternatively, the network 112 can receive service data 116 from the service data source 110, which may include, for example a computer-executed program that generates service data, and/or memory with data stored therein corresponding to service data. The service data 116 may include personal identifying information of a user, directed content to be sent to one or more users, a pre-configured conversion window during which it is desired for a user to perform an action, after receiving directed content, and/or other types of service data that may be recognized by those of ordinary skill in the art. In some examples, the service data 116 may include information corresponding to a marketing campaign, a video game, or an education campaign.

The server 104 receives the user data 114 from the user data source 108 and/or the computing devices 102, as well as service data 116 from the service data source 110 and/or the service devices 106. The server 104 may receive the user data 114 and the service data 116 via the network 112. Generally, the server may include one or more engines, components, or applications that act as a clean room for data from a plurality of sources to be received, without each of the plurality of data sources being able to access each other's respective sets of data.

In some examples, the computing device 102 may be a plurality of computing devices 102, such as in instances where user data 114 (e.g., location data, personal identifiable information, etc.) is desired to be received from a plurality of users. Additionally, or alternatively, in some examples, the service device 106 may be a plurality of service devices 106, such as in instances where service data 116 (e.g., personal identifiable information, directed content, pre-configured conversion windows, etc.) are desired to be received from a plurality of services (e.g., a commercial entity, hospital, video game, etc.).

In some examples, computing device 102, server 104, and/or service device 106 can be any suitable computing device or combination of devices, such as a desktop computer, a vehicle computer, a mobile computing device (e.g., a laptop computer, a smartphone, a tablet computer, a wearable computer, etc.), a server computer, a virtual machine being executed by a physical computing device, a web server, etc. In instances where there are a plurality of computing devices 102 and/or a plurality of servers 104, it should be recognized by those of ordinary skill in the art that user data 110 may be received at one or more of the plurality of computing devices 102 and/or one or more of the plurality of servers 104. Additionally, or alternatively, in instances where there are a plurality of service devices 106 and/or a plurality of servers 104, it should be recognized by those of ordinary skill in the art that service data 110 may be received at one or more of the plurality of service devices 106 and/or one or more of the plurality of servers 104.

In some examples, the computing device 102 may be a smartphone or tablet computing device that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the present disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

In some examples, user data source 108 can be any suitable source of user data. In a more particular example, user data source 108 can include memory storing user data (e.g., local memory of computing device 102, local memory of server 104, cloud storage, portable memory connected to computing device 102, portable memory connected to server 104, etc.). In another more particular example, user data source 108 can include an application configured to generate user data 114. In some examples, user data source 108 can be local to computing device 102. Additionally, or alternatively, user data source 108 can be remote from computing device 102 and can communicate user data 114 to computing device 102 (and/or server 104) via a communication network (e.g., communication network 112).

In some examples, service data source 110 can be any suitable source of service data. In a more particular example, service data source 110 can include memory storing service data (e.g., local memory of service device 106, local memory of server 104, cloud storage, portable memory connected to service device 106, portable memory connected to server 104, etc.). In another more particular example, service data source 110 can include an application configured to generate service data 116. In some examples, service data source 110 can be local to service device 106. Additionally, or alternatively, service data source 110 can be remote from service device 106 and can communicate service data 116 to service device 106 (and/or server 104) via a communication network (e.g., communication network 112).

In some examples, communication network 112 can be any suitable communication network or combination of communication networks. For example, communication network 112 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard), a wired network, etc. In some examples, communication network 112 can be a local area network (LAN), a wide area network (WAN), a public network (e.g., the Internet), a private or semi-private network (e.g., a corporate or university intranet), any other suitable type of network, or any suitable combination of networks. Communication links (arrows) shown in FIG. 1 can each be any suitable communications link or combination of communication links, such as wired links, fiber optics links, Wi-Fi links, Bluetooth links, cellular links, etc.

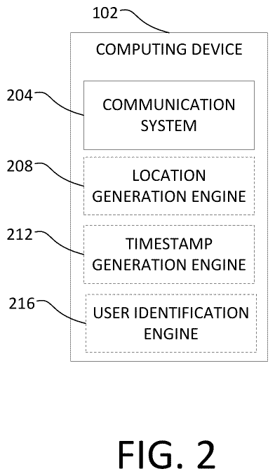

FIG. 2 illustrate a detailed view of the computing device 102, according to some aspects described herein. The computing device 102 includes a communication system 204, a location generation engine or component 208, a timestamp generation engine or component 212, and a user identification engine or component 216. Additional and/or alternative components of the computing device 102 may be recognized by those of ordinary skill in the art.

The location generation component 208 may generate or store (e.g., in a memory location corresponding to the location generation component 208) an indication corresponding to a location of a user. The location may be a physical geographic location that is generated based on, for example, a global positioning system, or a cellular system, or a visual location processing system, or a satellite system, or another type of location system that may be recognized by those of ordinary skill in the art. The location may be a geographic region, or a street address, or any other indication of a physical location. Additionally, or alternatively, the location may be a virtual location, such as a website, or a virtual reality environment.

The timestamp generation component 212 may generate or store (e.g., in a memory location corresponding to the timestamp generation component 212) an indication corresponding to a time at which the user arrives or is otherwise located at a location (e.g., as indicated by the location generation component 208). For example, the timestamp generation component 212 may generate the time at which a user arrives at a store, or arrives at a park, or navigates to a webpage, or arrives at a location in a virtual reality environment, or arrives at a hospital, or arrives at any other venue or locations of interest.

The user identification component 216 may generate or store (e.g., in a memory location corresponding to the user identification component 216) an indication corresponding to identifying information of a user. For example, the user identification component 216 may store labels corresponding to one or more users, or IP addresses corresponding to one or more users, or names corresponding to one or more users, or another type of identifying information that may be recognized by one of ordinary skill in the art.

Generally, the computing device 102 includes a plurality of components that generate location data for a user corresponding to a location of interest, timestamps corresponding to the location data, and a data set of indications that each correspond to a respective user of a set of users, such that the time that specific users arrive at specific locations can be monitored and stored, with a user's permission.

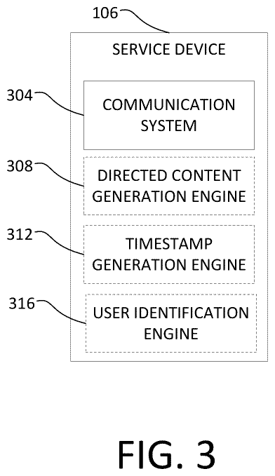

FIG. 3 illustrates a detailed view of the service device 106, according to some aspects described herein. The service device 106 includes a communication system 304, a directed content generation engine or component 308, a timestamp generation engine or component 312, and a user identification engine or component 316. Additional and/or alternative components of the service device 106 may be recognized by those of ordinary skill in the art.

The directed content generation engine 308 may generate or store (e.g., in a memory location corresponding to the directed content generation engine 308) content that is directed to one or more users. The directed content may be suitable for influencing a user to go to a physical or virtual location of interest. For example, in a gaming context, the directed content may instruct a user to go to a physical park, or a location in a virtual reality environment, to collect points for the game. Additionally, or alternatively, in a commercial context, the directed content may influence a user to go to a store or website to purchase an item. Additional and/or alternative examples of directed content may be recognized by those of ordinary skill in the art.

The timestamp generation component 312 may generate or store (e.g., in a memory location corresponding to the timestamp generation component 312) an indication corresponding to a time at which the user is provided with directed content (e.g., as generated or stored by the directed content generation engine 308). For example, the timestamp generation component 312 may generate the time at which directed content is provided to a user, on a computing device (e.g., computer, smartphone, wearable device, etc.) that is associated with the user.

The user identification component 316 may generate or store (e.g., in a memory location corresponding to the user identification component 316) an indication corresponding to identifying information of a user. For example, the user identification component 216 may store labels corresponding to one or more users, or IP addresses corresponding to one or more users, or account numbers that correspond to one or more users, or names corresponding to one or more users, or preferences of one or more users (e.g., gaming preferences, shopping preferences, etc.), or another type of identifying information that may be recognized by one of ordinary skill in the art to identify each of one or more users.

Generally, the service device 106 includes a plurality of components that generate directed content to be received by a user, timestamps corresponding to when the directed content is provided to the users, and a data set of indications that each correspond to a respective user of a set of users, such that the time that specific users are provided with directed content can be monitored and stored, with a user's permission.

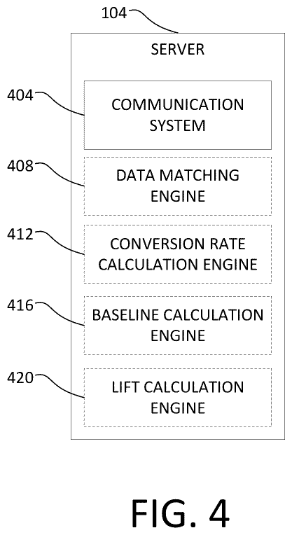

FIG. 4 illustrates a detailed view of the server 104, according to some aspects described herein. The server 104 includes a communication system 404, a data matching engine or component 408, a conversion rate calculation engine or component 412, a baseline calculation engine or component 416, and a lift calculation engine or component 420. Additional and/or alternative components of the server 104 may be recognized by those of ordinary skill in the art.

The data matching component 408 may match a first set of users (e.g., from data stored on the computing device 102) to a second set of users (e.g., from data stored on the service device 106). In some examples, further sets of users may be matched to the first set of users and the second set of users, such as in example where there are a plurality of computing devices 102 and/or a plurality of service device 106.

The data matching component 408 may match the sets of users based on the user identification components 316. For example, the same users may have similar identifying information, across devices from which the identifying information is received. In some examples, the data matching component 408 may include a model that is trained to match sets of data that correspond to the same user. The model may be a machine learning model that is trained based on sets of user data and pre-made matchings of users between the sets of user data. The matching performed by the model may have an associated confidence level that corresponds to a degree of accuracy with which sets of data are determined to be matched together.

The conversion rate calculation component 412 calculates a rate (e.g., number of instances) at which users go to a location of interest, after receiving related directed content. In some examples, the conversion rate calculation component 412 may determine which of a plurality of directed contents are successful in influencing a user to go to a location of interest, based on the merging of data sets, while preserving data privacy, that is described herein. The conversion rate calculation component may compare timestamps from a first data set (e.g., based on the timestamp generation component 212) to timestamps from a second data set (e.g., based on the timestamps generation component 312) to calculate how long after a user receives directed content that the user goes to a location of interest, corresponding to the received directed content. The duration of time in which a user goes to the location of interest, after receiving the directed content, may be compared to a pre-determined conversion window, such that, for example, if the time is within the pre-determined conversion window, then the instance of the user going to the location of interest increases the calculated rate.

The baseline calculation component 416 calculates and/or stores (e.g., in a memory location corresponding to the baseline calculation component 416) a rate (e.g., number of instances) at which a user goes to a location of interest, independent of receiving directed content. For example, a user may go to a park every Friday, without having received directed content that influences them to go to the park. Therefore, if a user then goes to the park on a Friday, after receiving directed content on the preceding Wednesday, then the user going to the park would likely not have been a result of the directed content. However, if the user were to go to the park on the Thursday, after receiving the directed content, then the user going to the park may likely have been a result of the directed content.

The baseline calculation component 416 may include a model that is trained to calculate a baseline conversion rate, for a user, based on one or more characteristics of the user. For example, the one or more characteristics, upon which the baseline conversion rate is based, may include demographic attributes such as age, gender, income, ethnicity, relationship status, and/or a number of children of the user. Additionally, or alternatively, the one or more characteristics may include a geographic area in which the user is located. Additionally, or alternatively, the one or more characteristics may include type of operating system of a computing device that is used by the user. For example, users who use a first operating system, as compared to a second operating system, may exhibit different behaviors that can be determined, in part, based on knowledge of which operating system is used by the user. In some examples, the one or more characteristics of the user may be used to train the model, with respect to pre-determined time-partitions. For example, a user's travel to a location of interest may be recorded within three-hour partitions, or within half-day partitions, or within day-long partitions, or within week-long partitions, or within any other partition of time that may be desirable to measure user activity to train a model using mechanisms disclosed herein. The partitions may be collected over a predetermined duration of time. For example, a collection of three-hour partitions may be collected continuously for the past 30 days, or 60 days, or 100 days, or any range defined between the aforementioned durations of time.

The lift calculation component 420 calculates and/or stores (e.g., in a memory location corresponding to the lift calculation component 420) a measurement of by how much the directed content (e.g., generated by the directed content generation component 308) influences a user to go to a location of interest, compared to how likely the user was to go to the location of interest, without receiving the directed content. The lift calculation is a change in conversion rate. Accordingly, the lift calculation may be the difference between a real conversion rate (e.g., from the conversion rate calculation engine 412) and a baseline conversion rate (e.g., from the baseline calculation engine 416). The lift calculation component may be used to determine an impact of directed content on a user. For example, if a real conversion rate is higher than a baseline conversion rate, then the directed content may positively affect a user being driven to a location of interest, based on the directed content. Alternatively, if a real conversion rate is the same as a baseline conversion rate, then the directed content may have no effect on a user being drive to a location of interest. Alternatively, if a real conversion rate is lower than a baseline conversion rate, then the directed content may negatively affect on a user being driven to a location of interest, based on the directed content.

Generally, the server 104 may receive a plurality of data sets for which a plurality of calculations may be performed, based thereon. However, the plurality of data sets may each be inaccessible by devices that are in communication with the server 104 and from which the respective data set was not received. In this regard, data sets may be private from devices other than those from which the data sets are stored. The server 104 may be a clean room in which sets of data are received. However, rather than the raw data being accessible by a plurality of devices, only relevant calculations (e.g., conversion rates, lift calculations, etc.) are received from the server 104. Calculations performed by the server 104 may be based on a single service device and a single user device. Alternatively, calculation performed by the server 104 may be based on a plurality of service devices and/or a plurality of user devices.

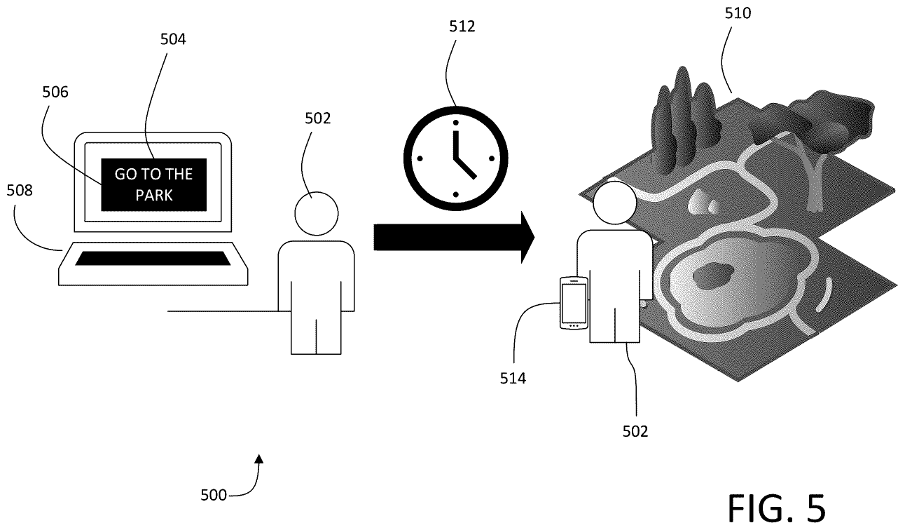

FIG. 5 illustrates an example use-case 500 for matching user information between data sets, while preserving data privacy, according to some aspects described herein. The use-case 500 includes one or more users 502. The one or more users 502 may receive directed content 504 from a service 506. The service 506 may be similar to one or more services associated with the service device 106, described earlier herein, with respect to FIG. 1. The service 506 may be accessed, run, presented, or otherwise provided, via a first computing device 508.

After receiving the directed content 504, the user 502 may be influenced to go to a venue or location of interest 510, based on the directed content. The time between when the user 502 receives the directed content 504 (e.g., view the directed content, hears the directed content, accesses the directed content, etc.) and the time when the user 502 arrives at the location of interest 510 may fall within a conversion window 512 (e.g., a pre-defined duration of time). For example, the time when the user 502 arrives at the location of interest 510 may be subtracted from the time when the user 502 receives the directed content, and the difference between the times may be compared to the conversion window 512. If the difference between the times is less than the value of the pre-defined conversion window 512, then the user 502 may be determined to have arrived at the location of interest 510, within the pre-defined conversion window 512. The number of instances that the user 502 arrives at the location of interest 510, within the pre-defined conversion window 512 is a conversion rate. In some examples, the conversion window 512, during which the user 502 arrives at the location of interest 510, after the user 502 received the directed content 504, may be measured in minutes, hours, days, weeks, years, or any other duration of time that may be recognized by those of ordinary skill in the art.

The time at which the user 502 arrives at the location of interest 510 may be based on location data received from a second computing device 514 that is associated with the user. For example, the computing device 514 may be a mobile computing device, such as a smartphone device, that contains a location sensor, such as a global positioning system (GPS). Additionally, or alternatively, the computing device 514 may include a camera that receives image data and determines a location of interest, based on the received image data. Additionally, or alternatively, location data for the computing device 514 may be received from cellular towers, WiFi networks, short-range wireless frequencies, or any other technological interface by which location data may be received.

The location of interest 510 may be a park, or a restaurant, or a mall, or a convention center, or a store, or a residential home, or a location in a virtual reality environment, or a website, or any other location that may be recognized by those of ordinary skill in the art. Physical locations of interest 510 may have associated geographic coordinates. Accordingly, when the user 502 travels to a physical location of interest, the computing device 514 may generate coordinate points, or other location-based data to provide an indication of the user's 502 position (i.e., being at the location of interest 510). Virtual locations of interest 510 may have associated URLs, or IP addresses, or any other virtual positioning within a virtual environment that may be recognized by those of ordinary skill in the art. Accordingly, when the user 502 travels or navigates to a virtual location of interest, the computing device 514 may generate an indication corresponding to the user's 502 position (i.e., being at the location of interest).

Generally, mechanisms disclosed herein may desire to match data corresponding to the user 502, from the service 506, to data corresponding to the user 502, from the computing device 514. However, administrators of the service 506 and administrators of one or more applications on the computing device 514 may not want to share their information with each other, to preserve secure privacy practices. Accordingly, a server (e.g., server 104 of system 100) may receive data corresponding to the user 502 from both of the service 506 and the computing device 514, without providing access to each other's respective data sets. In this regard, data corresponding to the user 502 can be matched, according to mechanisms disclosed herein, such that calculations or other further processing can be performed using merged data from a plurality of partnering sources (e.g., the service 506 and applications running on the computing device 514).

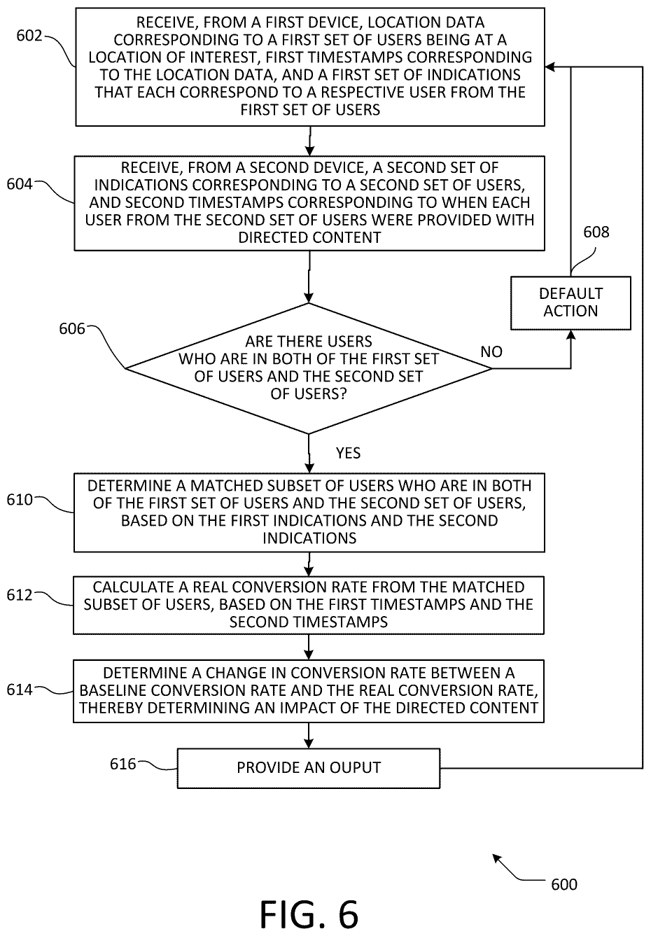

FIG. 6 illustrate an example method 600, according to some aspects described herein. The example method 600 may be a method of matching user information between data sets, while preserving data privacy. Additionally, or alternatively, the example method 600 may be a method of determining an impact of directed content, while preserving data privacy, between devices. In examples, aspects of method 600 are performed by a device, such as computing device 102, server 104, and/or service device 106, discussed above with respect to FIG. 1.

Method 600 begins at operation 602 wherein location data that corresponding to a first set of users being at a location of interest, first timestamps that correspond to the location data, and a first set of indications that each correspond to a respective user from the first set of users, are received, from, for example, a first device. The first device may be a computing device of a user, such as computing device 102 discussed earlier herein, with respect to FIG. 1. In some examples, the first device may be a plurality of first devices, such as a plurality of computing devices that each correspond to a respective one of a plurality of users.

In some examples, a pre-defined conversion time may further be received. The pre-defined conversion time may be a period of time, specified by a service, within which it is desired for a user to travel to a location of interest. For example, a commercial entity may desire for a user to travel to one of their stores, within a week, after the user received directed content that is designed to influence the user to go to one of their stores, such that the user may, for example, purchase a product. Alternatively, a gaming service may desire for a user to travel to a park, or a location within a virtual environment, within a few hours, after receiving directed content, such that the user may, for example, receive points or another type of reward.

The location of interest may be similar to the locations of interest discussed with respect to the location generation component 208. The first timestamps may be similar to the timestamps discussed with respect to the timestamp generation component 212. Further, the first set of indications may be similar to the user identifications discussed with respect to the user identification component 216. For example, the first set of indications may be identifiers (e.g., labels, IP addresses, identification numbers specific to one or more users, etc.) that correspond to the first set of users.

At operation 604, a second set of indications that correspond to a second set of users, and second timestamps that correspond to when each user from the second set of users were provided with directed content, are received, from, for example, a second device. The second device may be a service device, such as service device 106 discussed earlier herein, with respect to FIG. 3. In some examples, the second device may be a plurality of second devices that each correspond to a respective one of a plurality of services (e.g., a gaming service, a shopping service, a food delivery service, etc.).

The second timestamps may be similar to the timestamps discussed with respect to the timestamp generation component 312. Further, the second set of indications may be similar to the user identifications discussed with respect to the user identification component 316. For example, the second set of indications may be identifiers (e.g., labels, IP addresses, account numbers, etc.) that correspond to the second set of users.

According to mechanisms disclosed herein, the first device cannot access the second set of indications and the second device cannot access the first set of indications. Therefore, mechanisms herein ensure that privacy is established for data of the first device and data of the second device. Such technical effects are beneficial for generating reports and performing calculations, based on a plurality of data sets that may belong to different entities, while still ensuring that user information is protected.

At operation 606, it is determined if there are users who are in both of the first set of users (i.e., of operation 602) and the second set of users (i.e., of operation 604). For example, an application on a computing device may store information (e.g., in memory) of location data corresponding to a user, at a given time. Meanwhile, a service that is running on the computing device, or on a separate device, may store information regarding directed content that is provided to the user. It may be beneficial for the application and the service to receive reports or calculations based on both of their data sets. Therefore, models may be trained to determine if there are common users in both of the first set of users and the second set of users. Such models may be located in, or be determined based on, a data matching component of a server, such as the data matching component 408 of the server 104.

If it is determined that there are no users who are in both of the first set of users and the second set of users, then flow branches “NO” to operation 608, where a default action is performed. For example, none of the first set of users may have received content data, and may therefore be independent of the second set of users. In other examples, method 600 may comprise determining whether the first set of users or the second set of users an associated default action, such that, in some instances, no action may be performed as a result of the received first set of users and second set of users. Method 600 may terminate at operation 608. Alternatively, method 600 may return to operation 602 to provide an iterative loop of receiving data corresponding to a first set of users, and data corresponding to a second set of users, and determining if there are users who are in both of the first set of users and the second set of users.

If however, it is determined that there are users who are in both of the first set of users and the second set of users, flow instead branches “YES” to operation 610, where a matched subset of users who are in both of the first set of users and the second set of users is determined, based on the first indications and the second indications.

At operation 612, a real conversion rate is calculated from the matched subset of users, based on the first timestamps and the second timestamps. For example, if a second timestamp, from the second timestamps, corresponding to a first user, is three days after a first timestamp, from the first timestamps, corresponding to the first user, then the conversion rate for the first user may be three days. Alternatively, the real conversion rate may be a number of times that users travel to the location of interest, within a pre-configured duration of time (e.g., a conversion window). For example, if the pre-configured duration of time is five days, then the real conversion rate may be the number of times that the users travel to the location of interest, within the five days.

In some examples, a baseline conversion rate may further be calculated. The baseline conversion rate may be calculated by a baseline calculation component of a server, such as the baseline calculation component 416 of the server 104. The baseline conversion rate may be based on one or more characteristics of the first set of users. The one or more characteristics may include demographic attributes, such as, for example, age, gender, income, ethnicity, relationship status, and/or a number of children. The one or more characteristics may further include an operating system of the first device (e.g., of computing device 102). Additional and/or alternative characteristics may be recognized by those of ordinary skill in the art, at least in light of teaching described earlier herein with respect to the baseline calculation component 416.

At operation 614, a change in conversion rate between the baseline conversion rate and the real conversion rate is determined, thereby determining an impact of the directed content. For example, if the real conversion rate corresponds to a user traveling to the location of interest within five days, and the baseline conversion rate indicated that the user was expected to travel to the location of interest within five days, then there may be no change in conversion rate. However, if the real conversion rate corresponding to a user traveling to the location of interest within two days, and the baseline conversion rate indicated that the user was expected to travel to the location of interest within five days, then there may be a positive change in the conversion rate. A negative change in the conversion rate may also be calculated, as will be recognized.

Alternatively, if the real conversion rate corresponds to a number of times that users travel to the location of interest, within a pre-configured duration of time, after receiving content data, then the number of times may be compared to an expected number of times that correspond to the baseline conversion rate. If the number of times from the real conversion rate is larger than the number of times from the baseline conversion rate, then the directed content had a positive effect on the conversion rate. A degree of effect that the directed content had on the conversion rate may be determined by a ratio between the real conversion rate and the base conversion rate.

At operation 616, an output is provided. The output may be based on the change in conversion rate between the baseline conversion rate and the real conversion rate. For example, the output may be a report that includes a degree to which the directed content impacted the real conversion rate, relative to the baseline conversion rate. Additionally, or alternatively, the output may include a plurality of reports that include a degree to which different types of directed content impacted the real conversion rate.

Method 600 may terminate at operation 616. Alternatively, method 600 may return to operation 602 (or any other operation from method 600) to provide an iterative loop, such as of receiving sets of data from first and second devices, matching subsets of user data between both of the sets of data, and determining an impacted of directed content, based on a change in conversion rate.

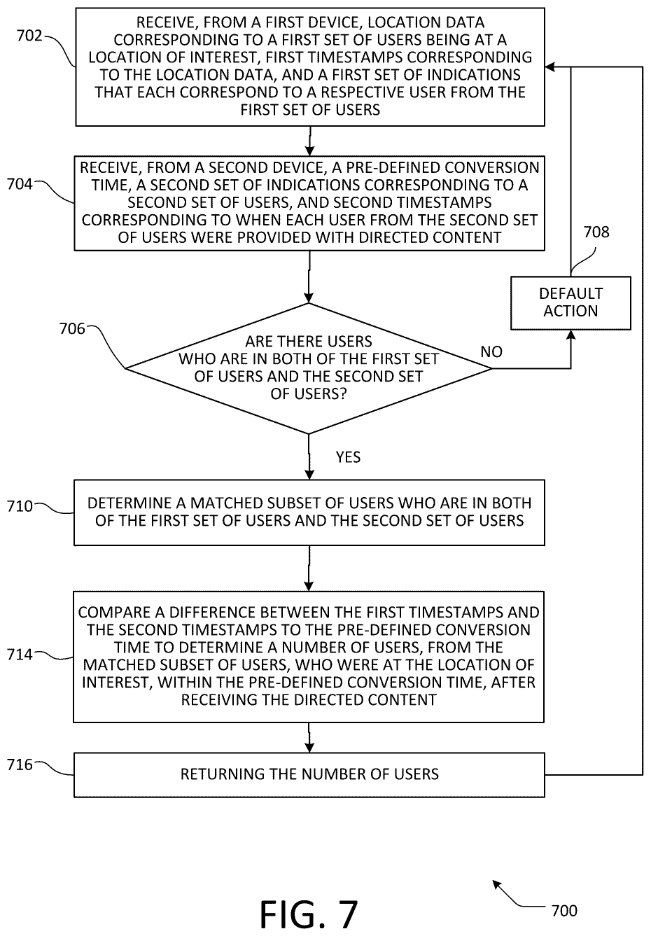

FIG. 7 illustrate an example method 700, according to some aspects described herein. The example method 700 may be a method of matching user information between data sets, while preserving data privacy. Additionally, or alternatively, the example method 700 may be a method of determining an impact of directed content, while preserving data privacy, between devices. In examples, aspects of method 700 are performed by a device, such as computing device 102, server 104, and/or service device 106, discussed above with respect to FIG. 1.

Method 700 begins at operation 702 wherein location data that corresponding to a first set of users being at a location of interest, first timestamps that correspond to the location data, and a first set of indications that each correspond to a respective user from the first set of users, are received, from a first device. The first device may be a computing device of a user, such as computing device 102 discussed earlier herein, with respect to FIG. 1. In some examples, the first device may be a plurality of first devices, such as a plurality of computing devices that each correspond to a respective one of a plurality of users.

The location of interest may be similar to the locations of interest discussed with respect to the location generation component 208. The first timestamps may be similar to the timestamps discussed with respect to the timestamp generation component 212. Further, the first set of indications may be similar to the user identifications discussed with respect to the user identification component 216. For example, the first set of indications may be identifiers (e.g., labels, IP addresses, identification numbers specific to one or more users, etc.) that correspond to the first set of users.

At operation 704, a pre-defined conversion time, a second set of indications that correspond to a second set of users, and second timestamps that correspond to when each user from the second set of users were provided with directed content, are received, from a second device. The second device may be a service device, such as service device 106 discussed earlier herein, with respect to FIG. 3. In some examples, the second device may be a plurality of second devices that each correspond to a respective one of a plurality of services (e.g., a gaming service, a shopping service, a food delivery service, etc.).

The pre-defined conversion time may be a period of time, specified by a service, within which it is desired for a user to travel to a location of interest. For example, a commercial entity may desire for a user to travel to one of their stores, within a week, after receiving directed content that is designed to influence the user to go to one of their stores, such that the user may purchase a product. Alternatively, a gaming service may desire for a user to travel to a park, or a location within a virtual environment, within a few hours, after receiving directed content, such that the user may receive points or another type of reward.

The second timestamps may be similar to the timestamps discussed with respect to the timestamp generation component 312. Further, the second set of indications may be similar to the user identifications discussed with respect to the user identification component 316. For example, the second set of indications may be identifiers (e.g., labels, IP addresses, account numbers, etc.) that correspond to the second set of users.

According to mechanisms disclosed herein, the first device cannot access the second set of indications and the second device cannot access the first set of indications. Therefore, mechanisms herein ensure that privacy is established for data of the first device and data of the second device. Such technical effects are beneficial for generating reports and performing calculations, based on a plurality of data sets that may belong to different entities, while still ensuring that user information is protected.

At operation 706, it is determined if there are users who are in both of the first set of users (i.e., of operation 702) and the second set of users (i.e., of operation 704). For example, an application on a computing device may store information (e.g., in memory) of location data corresponding to a user, at a given time. Meanwhile, a service that is running on the computing device, or on a separate device, may store information regarding directed content that is provided to the user. It may be beneficial for the application and the service to receive reports or calculations based on both of their data sets. Therefore, models may be trained to determine if there are common users in both of the first set of users and the second set of users. Such models may be located in, or be determined based on, a data matching component of a server, such as the data matching component 408 of the server 104.

If it is determined that there are no users who are in both of the first set of users and the second set of users, then flow branches “NO” to operation 708, where a default action is performed. For example, none of the first set of users may have received content data, and may therefore be independent of the second set of users. In other examples, method 700 may comprise determining whether the first set of users or the second set of users an associated default action, such that, in some instances, no action may be performed as a result of the received first set of users and second set of users. Method 700 may terminate at operation 708. Alternatively, method 700 may return to operation 702 to provide an iterative loop of receiving data corresponding to a first set of users, and data corresponding to a second set of users, and determining if there are users who are in both of the first set of users and the second set of users.

If however, it is determined that there are users who are in both of the first set of users and the second set of users, flow instead branches “YES” to operation 710, where a matched subset of users who are in both of the first set of users and the second set of users is determined, based on the first indications and the second indications.

At operation 712, a difference between the first timestamps and the second timestamps is compared to the pre-defined conversion time to determine a number of users, from the matched subset of users, who were at the location of interest, within the pre-defined conversion time, after receiving the directed content. For example, if the difference between the timestamps, for a given user, is three days, and the pre-defined conversion time is four days, then the number of users who were at the location of interest, within the pre-defined conversion time, after receiving the directed content, is increased by a count of one user. If the difference between the timestamps for a second user is two days, then the number of users who were at the location of interest, within the pre-defined conversion time, after receiving the directed content, has a total count of two users. This process may repeat for each user within the matched subset of users.

At operation 716, the number of users, determined from the comparison of operation 712, is returned. It should be noted that the number of users can be calculated without the first device receiving any data from the second device, and without the second device receiving any data from the first device.

Method 700 may terminate at operation 716. Alternatively, method 700 may return to operation 702 (or any other operation from method 700) to provide an iterative loop, such as of receiving sets of data from first and second devices, matching subsets of user data between both of the sets of data, and determining a number of users who were at a location of interest, within a pre-defined conversion time, after receiving directed content.

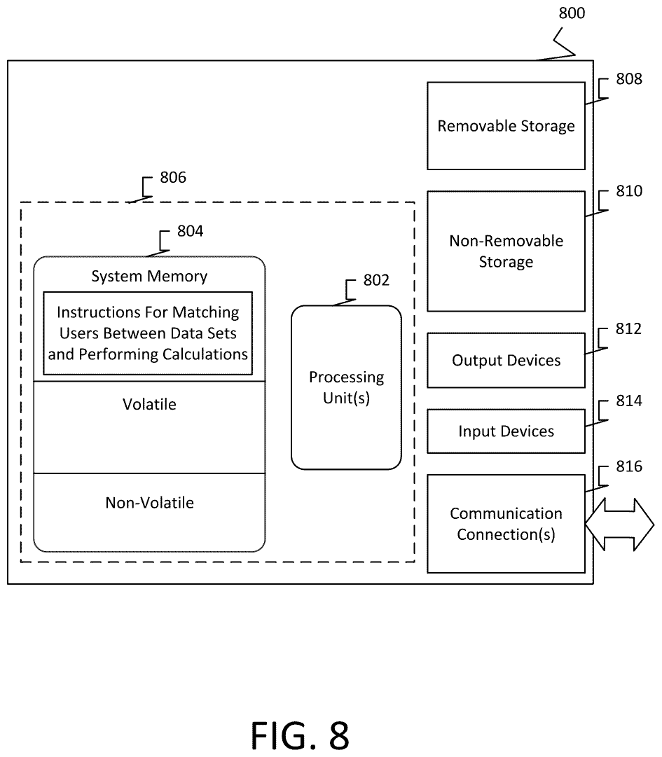

FIG. 8 illustrates a simplified block diagram of a device with which aspects of the present disclosure may be practiced in accordance with aspects of the present disclosure. The device may be a mobile computing device, for example. One or more of the present embodiments may be implemented in an operating environment 800. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, network PCs, minicomputers, mainframe computers, distributed computing environments that include any of the above systems or devices, and the like.

In its most basic configuration, the operating environment 800 typically includes at least one processing unit 802 and memory 804. Depending on the exact configuration and type of computing device, memory 804 (e.g., instructions for one or more aspects disclosed herein, such as one or more aspects of methods/processes 600 and 700, described with respect to FIGS. 6 and 7, respectively) may be volatile (such as RAM), non-volatile (such as ROM, flash memory, etc.), or some combination of the two. This most basic configuration is illustrated in FIG. 8 by dashed line 806. Further, the operating environment 800 may also include storage devices (removable, 808, and/or non-removable, 810) including, but not limited to, magnetic or optical disks or tape. Similarly, the operating environment 800 may also have input device(s) 814 such as remote controller, keyboard, mouse, pen, voice input, on-board sensors, etc. and/or output device(s) 812 such as a display, speakers, printer, motors, etc. Also included in the environment may be one or more communication connections 816, such as LAN, WAN, a near-field communications network, a cellular broadband network, point to point, etc.

Operating environment 800 typically includes at least some form of computer readable media. Computer readable media can be any available media that can be accessed by the at least one processing unit 802 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media. Computer storage media does not include a carrier wave or other propagated or modulated data signal.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The operating environment 800 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method comprising:
receiving, from a first device, location data corresponding to a first set of users being at a location of interest, first timestamps corresponding to the location data, and a first set of indications that each correspond to a respective user from the first set of users;
receiving, from a second device, a second set of indications corresponding to a second set of users, and second timestamps corresponding to when each of the users from the second set of users were provided with directed content;
determining a matched subset of users who are in both of the first set of users and the second set of users, based on the first set of indications and the second set of indications;
calculating a real conversion rate for the matched subset of users, based on the first timestamps and the second timestamps; and
determining a change in conversion rate between a baseline conversion rate and the real conversion rate, thereby determining an impact of the directed content;
providing an output, based on the change in conversion rate between the baseline conversion rate and the real conversion rate.

2. The method of claim 1, wherein the baseline conversion rate is calculated based on one or more characteristics of the first set of users, the one or more characteristics including demographic attributes.

3. The method of claim 1, wherein the directed content is content suitable for influencing a user to physically go to the location of interest.

4. The method of claim 1, wherein the first device cannot access the second set of indications, and wherein the second device cannot access the first set of indications, thereby establishing privacy for the first device and the second device.

5. The method of claim 1, wherein the first device is a plurality of first devices.

6. The method of claim 1, wherein the second device is a plurality of second devices.

7. The method of claim 1, wherein the first set of indication, and the second set of indications, are identifiers corresponding to the first set of users, and the second set of users, respectively.

8. A system comprising:
at least one processor; and
memory storing instructions that when executed, by the at least one processor, causes the system to perform a set of operations, the set of operations comprising:
receiving, from a first device, location data corresponding to a first set of users being at a location of interest, first timestamps corresponding to the location data, and a first set of indications that each correspond to a respective user from the first set of users;
receiving, from a second device, a pre-defined conversion time, a second set of indications corresponding to a second set of users, and second timestamps corresponding to when each of the users from the second set of users were provided with directed content;
determining a matched subset of users who are in both of the first set of users and the second set of users;
comparing a difference between the first timestamps and the second timestamps to the pre-defined conversion time to determine a number of users, from the matched subset of users, who were at the location of interest, after receiving the directed content, within the pre-defined conversion time; and
returning the number of users who were at the location of interest, within the pre-defined conversion time, after receiving the directed content.

9. The system of claim 8, wherein the matched subset of users is based on the first set of indications corresponding to the first set of users and the second set of indications corresponding to the second set of users.

10. The system of claim 8, wherein the directed content is suitable for influencing a user to physically go to the location of interest.

11. The system of claim 8, wherein the first device cannot access the second set of indications, and wherein the second device cannot access the first set of indications.

12. The system of claim 8, wherein the first device is a plurality of first devices.

13. The system of claim 8, wherein the second device is a plurality of second devices.

14. The system of claim 8, wherein the first set of indication, and the second set of indications, are identifiers corresponding to the first set of users, and the second set of users, respectively.

15. A method comprising:
receiving, location data corresponding to a first set of users being at a location of interest, first timestamps corresponding to the location data, and a first set of indications that each correspond to a respective user from the first set of users;
receiving a pre-defined conversion time, a second set of indications corresponding to a second set of users, and second timestamps corresponding to when each of the users from the second set of users were provided with directed content;
determining a matched subset of users who are in both of the first set of users and the second set of users;
calculating a baseline conversion rate based on one or more characteristics of the first set of users, the one or more characteristics comprising demographic attributes;
calculating a real conversion rate for the matched subset of users, based on the first timestamps and the second timestamps;
determining a change in conversion rate, based on the baseline conversion rate and the real conversion rate, thereby determining an impact of the directed content; and
providing an output, based on the change in conversion rate.

16. The method of claim 15, wherein the location data corresponding to the first set of users being at a location of interest, the first timestamps corresponding to the location data, and the first set of indications that each correspond to a respective user from the first set of users are all received from a first device, and
wherein the pre-defined conversion time, the second set of indications corresponding to the second set of users, and the second timestamps corresponding to when each of the users from the second set of users were provided with directed content are all received from a second device.

17. The method of claim 16, wherein one or more characteristics further comprise an operating system of the first device.

18. The method of claim 15, wherein the demographic attributes comprise one or more of age, gender, income, ethnicity, relationship status, and a number of children.

19. The method of claim 15, wherein the directed content is suitable for influencing a user to physically go to the location of interest.

20. The method of claim 15, wherein the matched subset of users is based on the first set of indications corresponding to the first set of users and the second set of indications corresponding to the second set of users.
